(19) United States
(12) Patent Application Publication
(10) Pub. No.: US 2026/0292116 A1
(43) Pub. Date: Sep. 24, 2026

(54) DISPLAY METHOD AND APPARATUS FOR OBJECTS TO BE DISPLAYED, ELECTRONIC DEVICE, AND MEDIUM

(71) Applicant: BEIJING UNICORN TECHNOLOGY CO., LTD., Beijing (CN)

(72) Inventors: Huijie Yuan, Beijing (CN); Hui Yin, Beijing (CN)

(21) Appl. No.: 19/470,046

(22) PCT Filed: Mar. 28, 2024
(86) PCT No.: PCT/CN2024/084549

§ 371 Date: Sep. 28, 2025

(30) Foreign Application Priority Data
Mar. 29, 2023 (CN) 202310324216.2

(51) Int. Cl. H04N 13/271; H04N 13/00; H04N 13/128

(52) U.S. Cl. CPC H04N 13/271; H04N 13/128; H04N 2013/0081

(57) ABSTRACT

The present disclosure provides a display method and apparatus for objects to be displayed, an electronic device, and a medium. A specific implementation solution is as follows: obtaining the original map and the first attribute information respectively corresponding to at least one target object to be displayed; rendering other objects to be displayed except the target object to be displayed based on the first pose of a terminal device and the second attribute information respectively corresponding to the other objects to be displayed to obtain at least one background map; and determining the image to be displayed based on the original map and the first attribute information respectively corresponding to each target object to be displayed, the at least one background map corresponding to the other objects to be displayed, and the second pose of the terminal device, wherein the second pose is obtained at a time later than the time when the first pose is obtained.

The present disclosure claims priority to Chinese patent application No. CN202310324216.2, filed with the China National Intellectual Property Administration on Mar. 29, 2023, and entitled “Display Method and Apparatus for Objects to be Displayed, Electronic Device, and Medium”, which is incorporated herein by reference in its entirety.

### TECHNICAL FIELD

The present disclosure relates to the field of display technology, and in particular to a display method and apparatus for objects to be displayed, an electronic device, and a medium.

### BACKGROUND

During operation of a virtual reality (VR) application, time warp is a technique for reducing latency between motion and images. Typically, after a first rendering is performed on an object in a virtual world, a map obtained from the first rendering is rendered a second time based on a latest pose to obtain an image to be displayed.

### SUMMARY

In view of this, an objective of the present disclosure is to provide a display method and apparatus for objects to be displayed, an electronic device, and a medium. For a target object to be displayed requiring high clarity among objects to be displayed, an image to be displayed may be determined based on an original map, and a map obtained after other objects to be displayed are rendered once, as well as a pose of a terminal device, so that the impact of double rendering on the clarity of a rendered image can be reduced, thereby effectively improving object clarity.

In a first aspect, embodiments of the present disclosure provide a display method for objects to be displayed, including: obtaining an original map and first attribute information respectively corresponding to at least one target object to be displayed; rendering other objects to be displayed except the target object to be displayed based on a first pose of a terminal device and second attribute information respectively corresponding to the other objects to be displayed to obtain at least one background map, wherein both the first attribute information and the second attribute information include position, angle, and scaling; and determining an image to be displayed based on the original map and the first attribute information respectively corresponding to each target object to be displayed, the at least one background map corresponding to the other objects to be displayed, and a second pose of the terminal device, wherein the second pose is obtained at a time later than a time when the first pose is obtained.

In a second aspect, embodiments of the present disclosure provide a computer-readable storage medium configured to store a computer program, wherein the computer program is configured to execute the display method for objects to be displayed according to any of the above-described embodiments of the present disclosure.

In a third aspect, embodiments of the present disclosure provide an electronic device including: a processor; and a memory configured to store instructions executable by the processor, wherein the processor is configured to read the executable instructions from the memory and execute the instructions to implement the display method for objects to be displayed according to any of the above-described embodiments of the present disclosure.

The technical solution of the present disclosure is further described in detail below in conjunction with the accompanying drawings and embodiments.

### BRIEF DESCRIPTION OF THE DRAWINGS

The above and other objects, features and advantages of the present disclosure will become more apparent from a more detailed description of embodiments of the present disclosure in conjunction with the accompanying drawings. The accompanying drawings are used to provide further understanding of embodiments of the present disclosure, and form part of the specification, and are used, together with embodiments of the present disclosure, for explaining the present disclosure, but do not limit the present disclosure. In the accompanying drawings, same reference numerals usually represent same components or steps.

FIG. 1 shows an exemplary system architecture applicable to embodiments of a display method or apparatus for objects to be displayed in the present disclosure;

FIG. 2 is a schematic flow diagram of a display method for objects to be displayed according to an exemplary embodiment of the present disclosure;

FIG. 3 is a schematic flow diagram of a display method for objects to be displayed according to another exemplary embodiment of the present disclosure;

FIG. 4 is a schematic flow diagram of a display method for objects to be displayed according to yet another exemplary embodiment of the present disclosure;

FIG. 5 is a schematic flow diagram of step 420 according to an exemplary embodiment of the present disclosure;

FIG. 6 is a schematic diagram of map intersection and occlusion according to an exemplary embodiment of the present disclosure;

FIG. 7 is a schematic structural diagram of a display apparatus for objects to be displayed according to an exemplary embodiment of the present disclosure;

FIG. 8 is a schematic structural diagram of a display apparatus for objects to be displayed according to another exemplary embodiment of the present disclosure; and

FIG. 9 is a schematic structural diagram of an application embodiment of an electronic device of the present disclosure.

### DETAILED DESCRIPTION

Exemplary embodiments according to the present disclosure will be described below in detail with reference to the accompanying drawings. Obviously, the described embodiments are merely part but not all of the embodiments of the present disclosure It should be understood that the present disclosure is not limited by the exemplary embodiments described here.

It is to be noted that unless specifically stated otherwise, the relative arrangement of components and steps, numerical expressions and numerical values set forth in these embodiments do not limit the scope of the present disclosure.

It may be understood by those skilled in the art that the terms “first”, “second” and the like in the embodiments of the present disclosure are only used to distinguish between different steps, devices or modules, etc., and do not represent any particular technical meaning or indicate an inevitable logical order thereof.

It should also be understood that in embodiments of the present disclosure, “plurality” may refer to two or more, and “at least one” may refer to one, two, or more.

Additionally, the term “and/or” in the present disclosure merely represents an association relationship describing associated objects, indicating there may be three relationships. For example, A and/or B may indicate three situations: A exists alone; both A and B exist; and B exists alone. Additionally, the character “/” in the present disclosure generally indicates that the associated objects prior to and following it are in an “or” relationship.

Technologies, methods, and devices known to those of ordinary skill in the related art may not be discussed in detail, but where appropriate, the technologies, methods, and devices should be regarded as part of the specification.

Embodiments of the present disclosure may be applied to electronic devices such as head-mounted display devices, terminal devices, and servers, which may operate with numerous other general-purpose or special-purpose computing system environments or configurations. The electronic devices such as head-mounted display devices, terminal devices, and servers may be described in the general context of computer system executable instructions (such as program modules) executed by a computer system. Typically, program modules may include routines, programs, target programs, components, logic, data structures, and so on, which perform specific tasks or implement specific abstract data types. The computer systems/servers may be implemented in a distributed cloud computing environment, in which tasks are performed by remote processing devices linked through a communication network. In the distributed cloud computing environment, the program modules may be located on a local or remote computing system storage medium that includes a storage device.

Specific implementations of the present disclosure will be described in detail below with reference to the accompanying drawings. It should be understood that the specific implementations described here are only used for illustrating and explaining the present disclosure, instead of limiting the present disclosure.

FIG. 1 shows an exemplary system architecture applicable to embodiments of a display method or apparatus for objects to be displayed in the present disclosure. The system architecture may include a head-mounted display device 1, a network 2, and a server 3. The network 2 may be a medium that provides a communication link between the head-mounted display device 1 and the server 3. The network 2 may include a variety of connection types, such as a wired or wireless communication link or a fiber optic cable.

The above-described head-mounted display device 1 may be an electronic device with an image display function, including but not limited to AR (Augmented Reality) smart glasses, VR (Virtual Reality) smart glasses, and so on. The head-mounted display device 1 may be an all-in-one unit. The functionality of a computing unit is integrated in the all-in-one head-mounted display device. The computing unit may provide processing capabilities for the head-mounted display device. Various client applications installed in the head-mounted display device are actually installed in the computing unit. Alternatively, the head-mounted display device may be a split-type device. The split-type head-mounted display device includes a head-mounted display, and a computing unit provided separately from the head-mounted display. A display screen of the head-mounted display is configured to display images processed by the computing unit. The computing unit in the split-type head-mounted display device may be a terminal device. The terminal device may be a mobile phone, a handle, an adapter, a PC, a tablet, an in-vehicle system, or the like. Here, for convenience of description, for cases where an executor is a head-mounted display device, solutions in the present disclosure will be described with an all-in-one head-mounted display device as the action executor throughout subsequent description herein, and it is denoted as a head-mounted display device 1 in the figure. Those skilled in the art should understand that, for a split-type head-mounted display device, an executor is a computing unit.

The head-mounted display device 1 may provide various services, such as obtaining an original map and first attribute information respectively corresponding to at least one target object to be displayed; rendering other objects to be displayed except the target object to be displayed based on a first pose of a terminal device and second attribute information respectively corresponding to the other objects to be displayed to obtain at least one background map, wherein both the first attribute information and the second attribute information include position, angle, and scaling; and determining an image to be displayed based on the original map and the first attribute information respectively corresponding to each target object to be displayed, the at least one background map corresponding to the other objects to be displayed, and a second pose of the terminal device, wherein the second pose is obtained at a time later than a time when the first pose is obtained. The display method for objects to be displayed according to embodiments of the present disclosure is generally performed by the above-descried head-mounted display device 1. Accordingly, the display apparatus for objects to be displayed is generally provided in the head-mounted display device 1. The display screen may be located in the display apparatus.

It should also be noted that the display method for objects to be displayed according to the present disclosure may also be applied to the server 3. The server 3 may be a backend page server. In the case where the method of the present disclosure is applied to the server 3, after obtaining an original map and first attribute information respectively corresponding to at least one target object to be displayed, the server 3 may render other objects to be displayed except the target object to be displayed based on a first pose of a terminal device and second attribute information respectively corresponding to the other objects to be displayed to obtain at least one background map, and thereby determine an image to be displayed based on the original map and the first attribute information respectively corresponding to each target object to be displayed, the at least one background map corresponding to the other objects to be displayed, and a second pose of the terminal device. Accordingly, the display apparatus for objects to be displayed may also be provided in the server 3.

In addition to the server and the head-mounted display device, the display method for objects to be displayed may also be applied to other terminal devices (not shown in the figure). The other terminal devices here may be mobile phones, tablets, computers, etc.

### Exemplary Method

The present disclosure provides a display method for objects to be displayed for a head-mounted display device. The objects to be displayed include a target object to be displayed and other objects to be displayed. The other objects to be displayed include at least one of a rear background type of objects to be displayed and a foreground type of objects to be displayed. The method includes: obtaining an original map and first attribute information of at least one target object to be displayed; rendering other objects to be displayed based on a first pose of the head-mounted display device and second attribute information of the other objects to be displayed to obtain at least one background map; determining a first rendering result corresponding to the target object to be displayed based on a second pose of the head-mounted display device, the original map, and the first attribute information, wherein the second pose is obtained at a time later than a time when the first pose is obtained; determining a second rendering result corresponding to the at least one background map based on the second pose and the at least one background map; and determining an image to be displayed based on the first rendering result and the second rendering result.

The present disclosure further provides another display method for objects to be displayed for a head-mounted display device. The objects to be displayed include a target object to be displayed and other objects to be displayed. The target object to be displayed has a first clarity requirement, and the other objects to be displayed have a second clarity requirement. The first clarity requirement is higher than the second clarity requirement. The method includes: obtaining an original map and first attribute information of at least one target object to be displayed; rendering other objects to be displayed based on a first pose of the head-mounted display device and second attribute information of the other objects to be displayed to obtain at least one background map; determining a first rendering result corresponding to the target object to be displayed based on a second pose of the head-mounted display device, the original map, and the first attribute information, wherein the second pose is obtained at a time later than a time when the first pose is obtained; determining a second rendering result corresponding to the at least one background map based on the second pose and the at least one background map; and determining an image to be displayed based on the first rendering result and the second rendering result.

In an optional example of the present disclosure, the image to be displayed may be determined based on the first rendering result, a layer level of the target object to be displayed, the second rendering result, and a layer level corresponding to the background map.

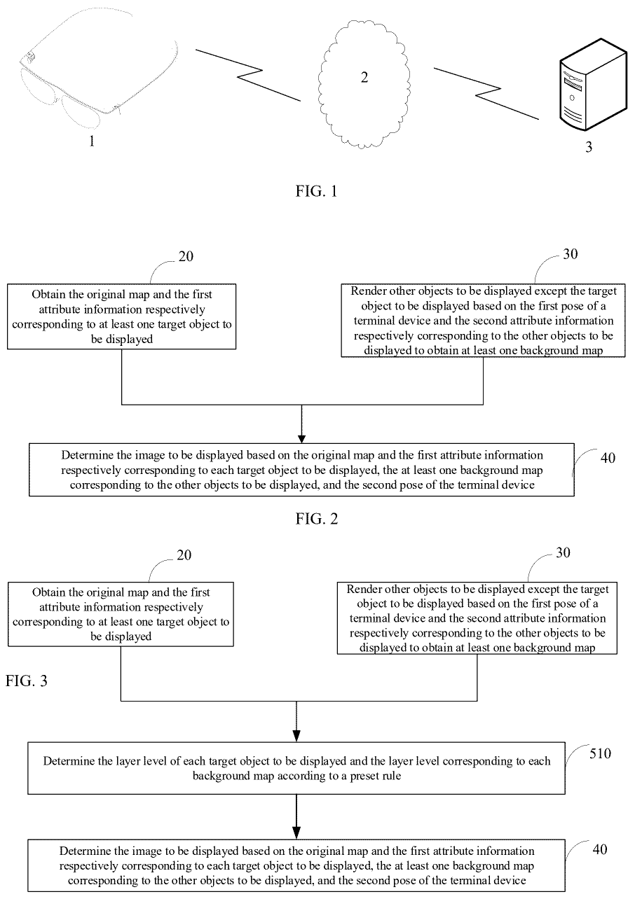

FIG. 2 is a schematic flow diagram of a display method for objects to be displayed according to an exemplary embodiment of the present disclosure. Embodiments of the present disclosure may be applied to an electronic device. As shown in FIG. 2, the method includes the following steps.

Step 20: Obtain an original map and first attribute information respectively corresponding to at least one target object to be displayed.

In some optional embodiments of the present disclosure, the target object to be displayed may be set according to a display clarity requirement. For example, the target object to be displayed may be at least one of an object of a document type, a web page type, an image type, and a video type (or categories). The original map corresponding to the target object to be displayed may be raw map data that has not undergone first rendering sampling (as in the related art). For different types of target objects to be displayed, their original maps may be obtained in different ways. For example, for a document-type object, the original map may be obtained through a text editor; for a web-page-type object, the original map may be obtained through a browser; for a video-type object, the original map may be obtained through a video player; for an image-type object, the original map may be obtained through an image viewer; and so on.

In some optional embodiments of the present disclosure, the first attribute information may be the attribute information of the target object to be displayed in a reference coordinate system. The reference coordinate system is a relatively stable coordinate system. For example, it may be a world coordinate system, or a three-dimensional spatial coordinate system rigidly connected to the world coordinate system and set based on application requirements. The first attribute information may include a position, angle, and scaling of the target object to be displayed. The position may be represented as coordinates of the target object to be displayed in the reference coordinate system. The angle may be represented as an attitude or orientation of the target object to be displayed in the reference coordinate system. The scaling may be represented as a scaling factor of the original map of the target object to be displayed. The first attribute information may be pre-set and stored for the original map. Alternatively, the first attribute information may change during application based on a user's adjustments, for example, when the user adjusts at least one of the position, angle and scaling of the target object to be displayed.

An executor (which may be a terminal device, such as a head-mounted display device or a server shown in FIG. 1) of the display method for objects to be displayed obtains the original map and the first attribute information respectively corresponding to the at least one target object to be displayed.

Step 30: Render other objects to be displayed except the target object to be displayed based on a first pose of a terminal device and second attribute information respectively corresponding to the other objects to be displayed to obtain at least one background map.

In some optional embodiments of the present disclosure, both the first attribute information and the second attribute information include position, angle, and scaling. For details, please refer to the foregoing description, which will not be repeated here.

In some optional embodiments of the present disclosure, the terminal device may be a device provided with a camera, such as a head-mounted display device, a mobile phone, or a tablet. The terminal device may be provided with an IMU (Inertial Measurement Unit) and at least one of other sensors capable of measuring the terminal device's velocity, acceleration, angle, angular velocity, etc. The first pose may include at least one of position and attitude. The first pose may be a pose of the terminal device obtained at a time of content generation for the other objects to be displayed, or a real-time pose of the terminal device obtained when at least one background map of the other objects to be displayed needs to be obtained, or a pose of the terminal device at the next display time, estimated when the other objects to be displayed need to be rendered. This may specifically be configured according to actual needs. The first pose may be obtained based on data collected by relevant sensors on the terminal device. For example, at least one of real-time positioning and pose estimation may be achieved based on the IMU and SLAM (Simultaneous Localization and Mapping). For an estimated pose of the terminal device, a specific pose estimation method may be set according to actual needs. For example, a preset pose estimation algorithm may also be used for estimation. The preset pose estimation algorithm may, for example, include any filtering algorithm, optimization algorithm, and so on. The filtering algorithm may, for example, be a One Euro filter algorithm, a Kalman filter algorithm, and so on. The optimization algorithm may include a least-squares optimization algorithm and other possible algorithms.

In some optional embodiments of the present disclosure, the other objects to be displayed may include all objects to be displayed except the target object to be displayed among the objects to be displayed, and the other objects to be displayed may include one or more objects to be displayed. The other objects to be displayed may, for example, include at least one of a rear background type of objects to be displayed and a foreground type of objects to be displayed. The rear background type of objects to be displayed may include at least one object to be displayed. The foreground type of objects to be displayed may also include at least one object to be displayed. This may specifically be configured according to actual needs.

In some optional embodiments of the present disclosure, rendering other objects to be displayed based on a first pose of the terminal device and second attribute information respectively corresponding to the other objects refers to: performing rendering according to a relative pose relationship between a virtual camera observation pose and the other objects to be displayed under the first pose, to obtain an image (i.e., a background map) of the other objects to be displayed that should be seen under the first pose. Depending on the specific type of the other objects to be displayed, at least one background map may be obtained according to actual needs. For example, for the rear background type of other objects to be displayed, at least one rear background map may be obtained; and for the foreground type of other objects to be displayed, at least one foreground map may be obtained.

A virtual camera may be in fixed connection with the terminal device, so the pose of the terminal device can also reflect the pose of the virtual camera.

The above-described steps 20 and 30 are not limited to any execution order, and may be performed sequentially or in parallel.

Step 40: Determine an image to be displayed based on the original map and the first attribute information respectively corresponding to each target object to be displayed, the at least one background map corresponding to the other objects to be displayed, and a second pose of the terminal device.

In some optional embodiments of the present disclosure, the second pose is obtained at a time later than a time when the first pose is obtained.

In some optional embodiments of the present disclosure, the second pose may be a latest pose of the terminal device, or may be an estimated pose of the terminal device at the next display time. For example, after completing the rendering of the other objects to be displayed to obtain the at least one background map, it is necessary to further determine the image to be displayed. At this time (which may be referred to as a current time), a real-time pose of the terminal device at the current time may be obtained as the second pose. Alternatively, a pose of the terminal device at the next display time, estimated at the current time, may be used as the second pose. This is not specifically limited.

In some optional embodiments of the present disclosure, a time indicated by the second pose is not earlier than a time indicated by the first pose. That is, a time of the terminal device's pose indicated by the second pose is not earlier than a time of the terminal device's pose indicated by the first pose. For example, the first pose corresponds to a current pose of the terminal device, indicating the current time, and the second pose corresponds to an estimated pose of the terminal device at the next display time, indicating the future next display time.

In some optional embodiments of the present disclosure, the first pose is a real-time pose of the terminal device obtained when the at least one background map of the other objects to be displayed needs to be obtained, and correspondingly, the second pose is a real-time pose of the terminal device obtained when the image to be displayed needs to be further determined after the rendering of the other objects to be displayed is completed.

In some optional embodiments of the present disclosure, the first pose is a real-time pose of the terminal device obtained when the at least one background map of the other objects to be displayed needs to be obtained, and the second pose is an estimated pose of the terminal device at the next display time.

In some optional embodiments of the present disclosure, the first pose is a first estimated pose of the terminal device at the next display time, estimated at any time prior to rendering the other objects to be displayed to obtain the at least one background map, and the second pose is a second estimated pose of the terminal device at the next display time, estimated at any time later than the prediction time of the first estimated pose.

In some optional embodiments of the present disclosure, if the second pose is the latest pose of the terminal device, the determined image to be displayed is an image to be displayed corresponding to the latest pose of the terminal device. The image to be displayed may be displayed on a display screen of the terminal device in real time, or may be displayed on the display screen when the next display time arrives.

In some optional embodiments of the present disclosure, if the second pose is the estimated pose of the terminal device at the next display time, the determined image to be displayed is an image to be displayed for the next display time. After the image to be displayed for the next display time is determined, the image to be displayed may be displayed on the display screen of the terminal device when the next display time arrives.

In some optional embodiments of the present disclosure, the principle for determining the second pose is similar to that for the first pose, and will not be described here. Since the second pose is obtained at a time later than a time when the first pose is obtained, the second pose is relatively closer to an actual pose of the terminal device at the next display time, and the second pose may exhibit some changes relative to the first pose, for example, in at least one of position and attitude.

To ensure low latency of the other objects to be displayed, time warping needs to be performed on the at least one background map of the other objects to be displayed, based on a pose change amount of the second pose relative to the first pose, so as to adjust their display positions, angles, and the like in the image to be displayed. For the target object to be displayed, time warping needs to be performed on the original map of the target object based on a relative pose relationship between a virtual camera observation pose and the first attribute information of the target object to be displayed under the second pose.

In the related art, all objects to be displayed are rendered according to a first pose to obtain a map, and subsequently, time warping is performed on the map based on a pose change amount of a second pose relative to the first pose to obtain an image to be displayed. This is equivalent to sampling the objects to be displayed, twice during both rendering and time warping processes, resulting in a problem of significant reduction in the clarity of the objects to be displayed.

In the display method for objects to be displayed in the present disclosure, for an object to be displayed (i.e., the target object to be displayed) whose high clarity needs to be ensured, the respective original map and first attribute information of the target object to be displayed are obtained, instead of rendering the target object to be displayed according to the first pose to obtain a map as in the related art. Based on the first attribute information of the target object to be displayed, time warping is performed directly on the original map of the target object to be displayed, according to the second pose. This reduces one sampling operation (essentially omitting the first sampling operation), and preserves, as much as possible, image information carried in the target object to be displayed, thereby achieving high-clarity display and improving user experience. For objects to be displayed whose expected clarity is not particularly high (i.e., the other objects to be displayed), rendering may be performed based on the first pose to obtain at least one background map, and then, time warping may be performed on each background map based on a pose change amount of the second pose relative to the first pose. This ensures the processing speed of the entire display solution while meeting the clarity requirement for the target object to be displayed.

In some optional embodiments of the present disclosure, the first attribute information may be used in combination with the second pose to determine a correspondence relationship between pixels of the image to be displayed and pixels of the original map, thereby allowing sampling from the original map based on the correspondence relationship to determine pixel color values of the target object to be displayed in the image to be displayed. This may specifically be configured according to actual needs, and this embodiment is not limited thereto.

In some optional embodiments of the present disclosure, in determining the image to be displayed, each target object to be displayed and the other objects to be displayed may be respectively rendered as different layer levels, and rendering results of the layer levels may be fused to obtain the image to be displayed; alternatively, sampling may be performed from the original map of each target object to be displayed and each background map of the other objects to be displayed, based on the pixels of the image to be displayed, to collect pixel values respectively corresponding to the pixels, and fusion may be performed based on layer levels to obtain the image to be displayed; and so on. This may specifically be configured according to actual needs. The layer level of each target object to be displayed and the layer levels of the other objects to be displayed may be determined according to a preset rule. The preset rule may be set according to actual needs. For example, the preset rule may include a positional relationship between each target object to be displayed and the background map of the other objects to be displayed, and may also include categories of each target object to be displayed and the other objects to be displayed, and so on.

In some optional embodiments of the present disclosure, the display screen of the terminal device may, for example, be a display screen of a head-mounted display device, a display screen of a mobile phone, a display screen of a tablet, etc., enabling the user to view, through the display screen, content of the image to be displayed.

In the display method for objects to be displayed according to embodiments of the present disclosure, for a target object to be displayed, an original map and first attribute information corresponding to the target object to be displayed may be obtained. For other objects to be displayed except the target object to be displayed, the other objects to be displayed may be rendered based on a first pose of a terminal device and second attribute information respectively corresponding to the other objects to be displayed to obtain at least one background map. Then, an image to be displayed is determined based on the original map and the first attribute information respectively corresponding to each target object to be displayed, the at least one background map corresponding to the other objects to be displayed, and a second pose of the terminal device. A sampling frequency for the target object to be displayed can be reduced with respect to the other objects to be displayed, thereby improving the clarity of the target object to be displayed in the image to be displayed and ensuring low display latency.

FIG. 3 is a schematic flow diagram of a display method for objects to be displayed according to another exemplary embodiment of the present disclosure.

In some optional embodiments of the present disclosure, the method of the present disclosure further includes the following step.

Step 510: Determine a layer level of each target object to be displayed and a layer level corresponding to each background map according to a preset rule.

In some optional embodiments of the present disclosure, the preset rule may include a positional relationship between each target object to be displayed and the background map of the other objects to be displayed, and may also include categories of each target object to be displayed and the other objects to be displayed, and so on. The positional relationships may include at least one of depth and occlusion. The categories may include a target category and a background category. The background category may be further divided into a foreground type and a rear background type.

In some optional embodiments of the present disclosure, the layer level of each target object to be displayed and the layer level corresponding to each background map may be represented in any manner, such as by numbers or other symbols. This may specifically be configured according to actual needs.

In an optional example of the present disclosure, the layer levels may be represented by layer numbers, such as 1, 2, 3, . . . A larger layer number indicates a higher layer level. For example, rear-background-type objects to be displayed may have a layer number of 0, and foreground-type objects to be displayed may have the largest layer number among all layer levels. The layer number of each target object to be displayed may be determined based on an occlusion relationship. For example, a layer level of an occluded object to be displayed is lower than that of a corresponding occluding object to be displayed.

In the display method for objects to be displayed according to embodiments of the present disclosure, by using the layer levels determined for each target object to be displayed and each background map, occlusion relationships between each target object to be displayed and the other objects to be displayed can be properly handled in the determination of the image to be displayed.

In some optional embodiments of the present disclosure, determining a layer level of each target object to be displayed and a layer level corresponding to each background map according to a preset rule in step 510 includes:
determining the layer level of each target object to be displayed and the layer level corresponding to each background map, according to a positional relationship among all target objects to be displayed and all background maps when the terminal device is in a target pose.

In some optional embodiments of the present disclosure, the target pose includes any of the first pose and the second pose. The positional relationship includes at least one of depth and occlusion.

In some optional embodiments of the present disclosure, when the terminal device is in the target pose, a camera or virtual camera of the terminal device is used to observe target objects to be displayed and background maps. Content that can be observed is influenced by positional relationships among the target objects to be displayed and the background maps relative to terminal device, for example, influenced by distance and angle. The distance may indicate a depth of an object to be displayed, and the angle may indicate an observing perspective. Different perspectives may result in different occlusion relationships among the objects to be displayed. For example, a rear background map of background maps should be a background map of other objects to be displayed that are farthest from the terminal device; target objects to be displayed occlude rear-background-type other objects to be displayed; foreground-type other objects to be displayed occlude the rear-background-type other objects to be displayed, and may also occlude part of the target objects to be displayed; and so on. Based on this principle, the layer level of each target object to be displayed and the layer level corresponding to each background map may be determined according to a positional relationship among all target objects to be displayed and all background maps when the terminal device is in the target pose. Depth information of the background maps relative to the camera or virtual camera under the target pose may be determined based on the second attribute information of the other objects to be displayed corresponding to the background maps and the target pose. Depth information of the target objects to be displayed under the target pose may be determined based on the first attribute information of the target objects to be displayed and the target pose.

In the display method for objects to be displayed according to embodiments of the present disclosure, the layer level of each target object to be displayed and the layer level corresponding to each background map may be determined according to a positional relationship among all target objects to be displayed and all background maps when the terminal device is in the target pose. This facilitates subsequent layer level fusion and improves processing efficiency.

In some optional embodiments of the present disclosure, determining a layer level of each target object to be displayed and a layer level corresponding to each background map according to a preset rule in step 510 includes:
determining the layer level of each target object to be displayed and the layer level corresponding to each background map, according to categories of all target objects to be displayed and all background maps, as well as a positional relationship among all target objects to be displayed and all background maps when the terminal device is in a target pose, wherein the categories include a target category and a background category; the target pose includes any one of the first pose and the second pose; and the positional relationship includes at least one of depth and occlusion.

In some optional embodiments of the present disclosure, objects to be displayed of background category may be rendered together to obtain one background map, and a layer level of the background map may be set to a topmost layer. For the target objects to be displayed, the layer level of each target object to be displayed may be determined according to a positional relationship under the target pose.

In some optional embodiments of the present disclosure, the background category may include a foreground type and a rear background type.

In some optional embodiments of the present disclosure, the other objects to be displayed of background category may include a rear background type and a foreground type. To further ensure the accuracy and effectiveness of the determined image to be displayed, the layer level of each target object to be displayed and the layer level of each background map may be determined according to categories of the target objects to be displayed and the background maps, as well as positional relationships among the target objects to be displayed and the background maps in a target pose. For example, layer level corresponding to a rear-background-type background map may be a bottommost layer; and a foreground-type background map may be arranged together with the target objects to be displayed in terms of layer levels according to their positional relationships.

In practical applications, the layer levels of the objects to be displayed may also be adjusted based on a user's operations on the objects to be displayed. For example, when a user drags a second object to be displayed that was originally occluded by a first object to be displayed, such that the second object to be displayed is moved into a state where it occludes the first object to be displayed, layer levels of the first object to be displayed and the second object to be displayed may be adjusted, and the image to be displayed may be determined based on the adjusted layer levels, so that the image to be displayed can be displayed in a timely manner corresponding to the user's operation.

In determining the layer levels of the target objects to be displayed, layer levels may be assigned randomly for target objects to be displayed and background maps that are not in an occlusion relationship. For example, there are two target objects to be displayed A and B, and one background map C. If A, B and C do not occlude each other when the terminal device is in the target pose, a depth relationship among A, B and C may be ignored, and layer numbers corresponding to their respective layer levels may be randomly assigned as 1, 2, and 3 without affecting a final display effect on the image to be displayed.

In the display method for objects to be displayed according to embodiments of the present disclosure, by determining the layer level of each target object to be displayed and the layer level of each background map according to categories of all target objects to be displayed and all background maps, as well as a positional relationship among all target objects to be displayed and all background maps when the terminal device is in a target pose, the accuracy and effectiveness of the layer levels can be further improved, providing a more accurate layer level reference for subsequently determining the image to be displayed.

In some optional embodiments of the present disclosure, in the case where there is no mutual occlusion between the target object to be displayed and the background map that are to be displayed in the image to be displayed, the image to be displayed may also be determined directly based on the original map and the first attribute information corresponding to the target object to be displayed, the background map, and the second pose of the terminal device, without the processing of layer level determination.

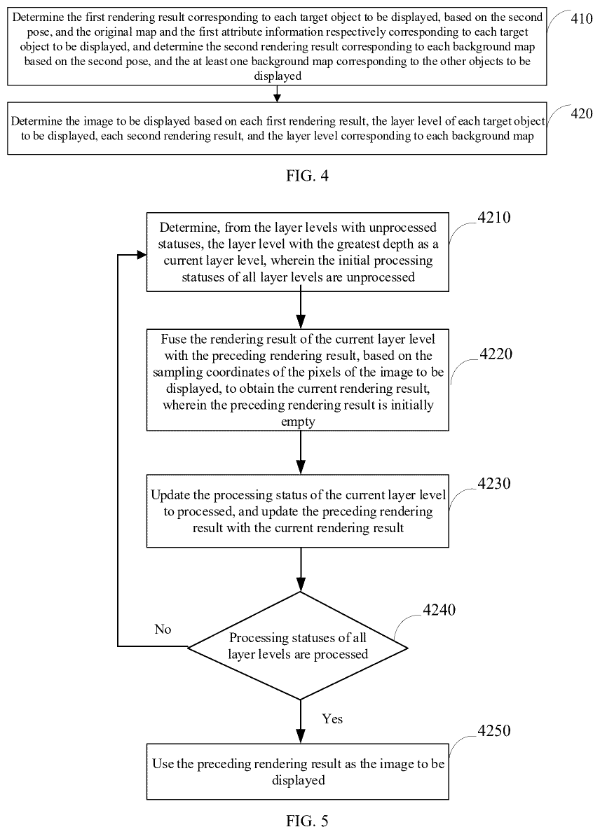

FIG. 4 is a schematic flow diagram of a display method for objects to be displayed according to another exemplary embodiment of the present disclosure.

In some optional embodiments of the present disclosure, determining an image to be displayed based on the original map and the first attribute information respectively corresponding to each target object to be displayed, the at least one background map corresponding to the other objects to be displayed, and a second pose of the terminal device in step 40 includes the following steps.

Step 410: Determine a first rendering result corresponding to each target object to be displayed, based on the second pose, and the original map and the first attribute information respectively corresponding to each target object to be displayed, and determine a second rendering result corresponding to each background map based on the second pose, and the at least one background map corresponding to the other objects to be displayed.

In some optional embodiments of the present disclosure, for each target object to be displayed, a correspondence between pixels of the image to be displayed and pixels of the original map may be determined based on the second pose and first attribute information. On this basis, pixel values may be sampled from the original map, to determine at least one of corresponding pixel values of the target object to be displayed at pixels of the image to be displayed or sampling coordinates of the pixels of the image to be displayed in the original map, as the first rendering result corresponding to the target object to be displayed. For the determination of the correspondence relationship between the pixels of the image to be displayed and the pixels of the original map, reference may be made to the foregoing description, which will not be repeated here.

In some optional embodiments of the present disclosure, for each background map, a correspondence relationship between the pixels of the image to be displayed and pixels of the background map may be determined based on the second pose and the first pose. On this basis, the second rendering result corresponding to the background map may be obtained. The principle for determining this correspondence relationship is similar to that for the original map described above, which will not be repeated here.

Step 420: Determine the image to be displayed based on each first rendering result, the layer level of each target object to be displayed, each second rendering result, and the layer level corresponding to each background map.

In some optional embodiments of the present disclosure, the determination of the image to be displayed may be implemented in any implementable manner. For example, rendering results of respective layer levels are overlaid layer by layer based on the layer levels and clipped according to the image to be displayed to obtain the image to be displayed. As another example, rendering results may be overlaid and clipped according to a certain number of layer levels to determine the image to be displayed. Alternatively, overlaying and clipping may be performed for all layer levels together to determine the image to be displayed. This may specifically be configured according to actual needs.

In the display method for objects to be displayed according to embodiments of the present disclosure, rendering is performed based on layer levels to obtain rendering results respectively corresponding to the layer levels, and then the rendering results of the layer levels are fused to obtain the image to be displayed. This achieves effective determination of the image to be displayed, and ensures the clarity of the target object to be displayed in the image to be displayed.

In some optional embodiments of the present disclosure, determining a first rendering result corresponding to each target object to be displayed, based on the second pose, and the original map and the first attribute information respectively corresponding to each target object to be displayed in step 410 includes:
for any target object to be displayed, determining sampling coordinates of pixels of the image to be displayed in the original map of the target object to be displayed, based on the second pose, and the original map and the first attribute information of the target object to be displayed; and determining a first rendering result corresponding to the target object to be displayed, based on the sampling coordinates of the pixels in the original map of the target object to be displayed.

In some optional embodiments of the present disclosure, the sampling coordinates of the pixels of the image to be displayed in the original map of the target object to be displayed may be determined based on a transformation relationship between pixel coordinates of the image to be displayed and pixel coordinates of the original map. This transformation relationship may be determined by the second pose and a pose of the original map indicated by the first attribute information of the original map.

In the display method for objects to be displayed according to embodiments of the present disclosure, sampling coordinates of pixels of the image to be displayed in the original map of the target object to be displayed are determined based on the second pose, and the original map and the first attribute information of the target object to be displayed; and based on the sampling coordinates of the pixels in the original map of the target object to be displayed, time-warped pixel values at the layer level of the target object to be displayed may be determined in the subsequent determination of the image to be displayed, providing an accurate first rendering result for the determination of the image to be displayed.

In some optional embodiments of the present disclosure, determining a second rendering result corresponding to each background map based on the second pose, and the at least one background map corresponding to the other objects to be displayed in step 410 includes:
for any background map, determining sampling coordinates of pixels of the image to be displayed in the background map based on the second pose; and determining a second rendering result corresponding to the background map based on the sampling coordinates of the pixels in the background map.

In some optional embodiments of the present disclosure, the determination of the second rendering result corresponding to the background map is similar to that of the first rendering result of the target object to be displayed. By using the second pose and the first pose of the background map, a correspondence relationship between the pixels of the image to be displayed and sampling coordinates of the background map is established to determine the sampling coordinates of the pixels of the image to be displayed in the background map. The specific principle will not be described here.

In the display method for objects to be displayed according to embodiments of the present disclosure, sampling coordinates of pixels of the image to be displayed in the background map are determined to determine a second rendering result corresponding to the background map. This achieves time warping of the background map and image clipping, providing an accurate and effective second rendering result for the determination of the image to be displayed.

In some optional embodiments of the present disclosure, FIG. 5 is a schematic flow diagram of step 420 according to an exemplary embodiment of the present disclosure. Referring to FIG. 5, determining the image to be displayed based on each first rendering result, the layer level of each target object to be displayed, each second rendering result, and the layer level corresponding to each background map in step 420 includes the following steps.

Step 4210: From layer levels with unprocessed statuses, determine a layer level with the greatest depth as a current layer level, wherein initial processing statuses of all layer levels are unprocessed.

In some optional embodiments of the present disclosure, processing statuses of all layer levels may be initialized as unprocessed. The layer level with the greatest depth is a layer that may be occluded by other layers. Therefore, starting from the layer level with the greatest depth, the layer level with the greatest depth is used as the current layer level.

Step 4220: Based on sampling coordinates of pixels of the image to be displayed, fuse a rendering result of the current layer level with a preceding rendering result to obtain a current rendering result, wherein the preceding rendering result is initially empty.

In some optional embodiments of the present disclosure, the preceding rendering result refers to a rendering result obtained through fusion during processing of the previous layer level. Fusing the rendering result of the current layer level with the preceding rendering result may be: fusing color values of pixels in the rendering result of the current layer level with color values of pixels in the preceding rendering result on the basis of the preceding rendering result. The color values may include values of three color channels, R (RED), G (GREEN), and B (BLUE), as well as opacity. As for the fusion of the color values, based on the opacity, the color values of the rendering result of the current layer level can occlude the color values of the preceding rendering result using the corresponding opacity. For example, if the opacity of the color value of a pixel of the current layer level is 1, a result after fusion for the pixel is the color value of the current layer level. On this basis, the current rendering result may be obtained. The opacity may be set to 1 by default, and may also be set to a value between 0 and 1.

In some optional embodiments of the present disclosure, the first rendering result and the second rendering result may be rendering results clipped according to the image to be displayed, or may be unclipped rendering results. For the unclipped rendering results, clipping may be performed during fusion so that the fused current rendering result is a rendering result adapted to the image to be displayed.

Step 4230: Update the processing status of the current layer level to processed, and update the preceding rendering result with the current rendering result.

In some optional embodiments of the present disclosure, after the current rendering result is obtained, to avoid repeated processing, the processing status of the current layer level is updated to processed, and the preceding rendering result is updated with the current rendering result.

In some optional embodiments of the present disclosure, the preceding rendering result may be stored in a render buffer. When the preceding rendering result is updated with the current rendering result, the current rendering result may replace the preceding rendering result in the render buffer.

Step 4240: Determine whether processing statuses of all layer levels are processed.

In response to a negative determination result, step 4210 is repeated: the step of determining, from layer levels with unprocessed statuses, a layer level with the greatest depth as a current layer level.

For the specific operation of this step, please refer to the foregoing description, which will not be repeated here.

In response to processing statuses of all layer levels being processed, step 4250 is executed: using the preceding rendering result as the image to be displayed.

In some optional embodiments of the present disclosure, when the processing statuses of all layer levels are processed, it indicates that the fusion of rendering results of all layer levels is completed, and the finally obtained preceding rendering result is used as the image to be displayed, so as to display the image to be displayed on the display screen of the terminal device when the image to be displayed needs to be displayed.

In the display method for objects to be displayed according to embodiments of the present disclosure, the determination of the image to be displayed is achieved through layer-by-layer fusion in the order of layer levels.

In some optional embodiments of the present disclosure, determining the image to be displayed based on each first rendering result, the layer level of each target object to be displayed, each second rendering result, and the layer level corresponding to each background map in step 420 includes:
determining, from layer levels with unprocessed statuses, a preset number of layer levels with the greatest depths as current target layer levels, wherein initial processing statuses of all layer levels are unprocessed; based on sampling coordinates of pixels of the image to be displayed, fusing rendering results of the current target layer levels with a preceding rendering result in the order of layer levels to obtain a current rendering result, wherein the preceding rendering result is initially empty; updating the processing statuses of the current target layer levels to processed, and updating the preceding rendering result with the current rendering result; repeating the step of determining, from layer levels with unprocessed statuses, a preset number of layer levels with the greatest depths as current target layer levels; and in response to processing statuses of all layer levels being processed, using the preceding rendering result as the image to be displayed.

In some optional embodiments of the present disclosure, the preset number may be configured according to actual needs. For example, it may be configured as two, three, and so on. The process of fusing the rendering results of the current target layer levels with the preceding rendering result in the order of layer levels may be layer-by-layer fusion, or may be pixel-by-pixel fusion. The layer-by-layer fusion is similar to the above-described layer-by-layer fusion. It may mean that fusing is performed on the current target layer levels in the order of layer levels to obtain a temporary fusion result, and then the temporary fusion result is fused with the preceding rendering result to obtain the current rendering result. The pixel-by-pixel fusion means that for any pixel of the image to be displayed, a fused pixel value corresponding to the pixel is determined according to the order of layer levels based on corresponding sampling coordinates of the pixel at the current target layer levels and in the preceding rendering result. This may specifically be configured according to actual needs. Fusion may be performed sequentially or in parallel for pixels. This may specifically be configured according to actual needs.

In the display method for objects to be displayed according to embodiments of the present disclosure, by performing fusion in the order of layer levels using a preset number of layer levels as current target layer levels to determine the image to be displayed, processing efficiency can be improved.

In some optional embodiments of the present disclosure, determining the image to be displayed based on each first rendering result, the layer level of each target object to be displayed, each second rendering result, and the layer level corresponding to each background map in step 420 includes:
based on sampling coordinates of pixels of the image to be displayed, fusing rendering results of all layer levels in the order of layer levels to obtain the image to be displayed.

In some optional embodiments of the present disclosure, based on the sampling coordinates of the pixels of the image to be displayed, corresponding pixel values may be obtained from the rendering results of the layer levels, and the pixel values of all layer levels may be fused in the order of layer levels. During the fusion, the rendering results may be clipped according to the image to be displayed so that a fusion result can adapt to the image to be displayed.

In the display method for objects to be displayed according to embodiments of the present disclosure, based on sampling coordinates of pixels of the image to be displayed, rendering results of all layer levels can be fused in the order of layer levels, and by iterating through the pixels of the image to be displayed once, pixel values of the pixels of the image to be displayed can be obtained, thereby improving fusion efficiency.

In some optional embodiments of the present disclosure, determining an image to be displayed based on the original map and the first attribute information respectively corresponding to each target object to be displayed, the at least one background map corresponding to the other objects to be displayed, and a second pose of the terminal device in step 40 includes:
for any pixel of the image to be displayed, respectively determining sampling coordinates corresponding to the pixel at each layer level based on the second pose, and fusing color values at corresponding sampling coordinates at all layer levels in maps corresponding to the layer levels in the order of layer levels to obtain a color value corresponding to the pixel.

In some optional embodiments of the present disclosure, after the at least one background map corresponding to the other objects to be displayed is obtained, for any pixel of the image to be displayed, sampling coordinates corresponding to the pixel may be directly determined respectively at each layer level based on the second pose, and color values of the pixel at corresponding sampling coordinates at all layer levels may be fused in the order of layer levels to obtain the color value corresponding to the pixel. On this basis, color values of all pixels of the image to be displayed may be obtained, thereby determining the image to be displayed. Since the rendering process for each layer level is omitted, and the pixel values of the pixels of the image to be displayed can be obtained by iterating through the pixels of the image to be displayed once, processing efficiency can be further improved.

In some optional embodiments of the present disclosure, determining an image to be displayed based on the original map and the first attribute information respectively corresponding to each target object to be displayed, the at least one background map corresponding to the other objects to be displayed, and a second pose of the terminal device in step 40 includes:
for any pixel of the image to be displayed, respectively determining sampling coordinates corresponding to the pixel in each map based on the second pose, and fusing color values in all maps at corresponding sampling coordinates in the maps in the depth order of the maps under the second pose to obtain a color value corresponding to the pixel.

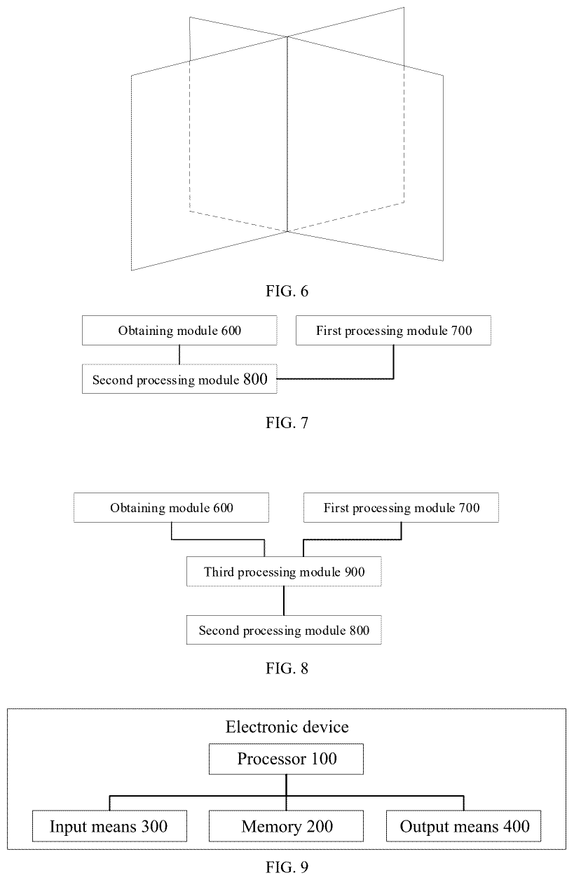

Referring to FIG. 6, there is a case where a single map exhibits inconsistent depths under the same pose. If two maps intersect, portions of pixels of each map may be occluded by the other map. Since the color values at the sampling coordinates in the maps are fused pixel by pixel in the order of depths under the second pose, the obtained image to be displayed is more accurate in the case where objects to be displayed intersect and occlude each other.

In some optional embodiments of the present disclosure, after maps are obtained, for any pixel of the image to be displayed, sampling coordinates corresponding to the pixel may be directly determined respectively in each map based on the second pose, and color values of the pixel at corresponding sampling coordinates in all maps may be fused in the order of depths under the second pose to obtain a color value of the pixel. On this basis, color values of all pixels of the image to be displayed may be obtained, thereby determining the image to be displayed. In addition to saving the rendering process for each layer level and improving processing efficiency, it can well resolve the map intersection and occlusion issue, so that the obtained image to be displayed is more realistic and natural.

In some optional embodiments of the present disclosure, the color values may include values of three color channels, R (RED), G (GREEN), and B (BLUE), as well as opacity.

In some optional embodiments of the present disclosure, determining the image to be displayed based on each first rendering result, the layer level of each target object to be displayed, each second rendering result, and the layer level corresponding to each background map in step 420 includes:
in the case where the other objects to be displayed correspond to one background map, and a layer level corresponding to the background map is a topmost layer, if at least a portion of a second rendering result corresponding to the background map needs to be occluded by the target object to be displayed, setting the opacity of pixels in an occluded portion of the second rendering result to transparency; and fusing rendering results of layer levels in the order of layer levels to obtain the image to be displayed.

In some optional embodiments of the present disclosure, in the case where the other objects to be displayed correspond to one background map, for example, for a background map that includes both rear background and foreground, a layer level corresponding to the background map may be set to a topmost layer. During application, due to a user's operation or other factors, the target object to be displayed may be moved to a location in front of the other objects to be displayed corresponding to the background map for display. In this case, at least a portion of a second rendering result corresponding to the background map needs to be occluded by the target object to be displayed. Based on this occlusion relationship, the opacity of pixels in an occluded portion of the second rendering result of the background map may be set to transparency, while the opacity of pixels in a portion of the second rendering result that is not occluded or needs to occlude the target object to be displayed may be maintained at a default value (the default value may, for example, be 1 indicating opaque, or 0.5, 0.9 or other values indicating partial transparency), to achieve an occluded effect when rendering results of layer levels are fused in the order of layer levels, thereby obtaining an accurate image to be displayed.

In the display method for objects to be displayed according to embodiments of the present disclosure, setting the opacity of the pixels in the occluded portion of the second rendering result of the topmost background map to transparency can achieve an effect of a lower layer level occluding a higher layer level, thereby resolving a display issue arising from a change in positional relationship between objects to be displayed during application.

In some optional embodiments of the present disclosure, in the case where the other objects to be displayed correspond to one background map, and the background map is positioned at a topmost layer, determining an image to be displayed based on the original map and the first attribute information respectively corresponding to each target object to be displayed, the at least one background map corresponding to the other objects to be displayed, and a second pose of the terminal device in step 40 includes:
if at least a portion of the background map needs to be occluded by the target object to be displayed under the second pose, setting the opacity of pixels in an occluded portion of the background map to transparency. The target object to be displayed is determined by the corresponding original map and first attribute information, and
fusing maps in the depth order of the maps under the second pose to obtain the image to be displayed.

In some optional embodiments of the present disclosure, in the case where the other objects to be displayed correspond to one background map, and the background map is positioned at a topmost layer, by setting the opacity of pixels in the background map that need to be occluded by the target object to be displayed to transparency (e.g., an opacity of 0), a windowing-like effect can be achieved in the background map. Although the background map is positioned at the topmost layer, a visual effect of the target object occluding the background map can be observed. Moreover, after maps are obtained, for any pixel of the image to be displayed, sampling coordinates corresponding to the pixel may be directly determined respectively in each map based on the second pose, and color values of the pixel at corresponding sampling coordinates in all maps may be fused in the order of depths under the second pose to obtain a color value of the pixel. In addition to improving processing efficiency, this can resolve the map intersection and occlusion issue, so that the obtained image to be displayed is more realistic and natural.

The above-described embodiments of the present disclosure may be implemented individually, or may be implemented in any combination without conflict with one another. This may specifically be configured according to actual needs, and the present disclosure is not limited thereto.

Any display method for objects to be displayed according to embodiments of the present disclosure may be executed by any suitable device having data processing capabilities, including, but not limited to a terminal device and a server. Alternatively, any display method for objects to be displayed according to embodiments of the present disclosure may be executed by a processor. For example, the processor executes any display method for objects to be displayed according to embodiments of the present disclosure by invoking corresponding instructions stored in a memory. This will not be described here.

### Exemplary Apparatus

FIG. 7 is a schematic structural diagram of a display apparatus for objects to be displayed according to an exemplary embodiment of the present disclosure. The apparatus in this embodiment may be used to implement a corresponding method embodiment of the present disclosure. The apparatus shown in FIG. 7 includes: an obtaining module 600, a first processing module 700, and a second processing module 800.

The obtaining module 600 is configured to obtain an original map and first attribute information respectively corresponding to at least one target object to be displayed.

The first processing module 700 is configured to render other objects to be displayed except the target object to be displayed based on a first pose of a terminal device and second attribute information respectively corresponding to the other objects to be displayed to obtain at least one background map, wherein both the first attribute information and the second attribute information include position, angle, and scaling.

The second processing module 800 is configured to determine an image to be displayed based on the original map and the first attribute information respectively corresponding to each target object to be displayed, the at least one background map corresponding to the other objects to be displayed, and a second pose of the terminal device, wherein the second pose is obtained at a time later than a time when the first pose is obtained.

FIG. 8 is a schematic structural diagram of a display apparatus for objects to be displayed according to another exemplary embodiment of the present disclosure.

In some optional embodiments of the present disclosure, the apparatus of the present disclosure further includes: a third processing module 900 configured to determine a layer level of each target object to be displayed and a layer level corresponding to each background map according to a preset rule.

In some optional embodiments of the present disclosure, the second processing module 800 is specifically configured to:
determine a first rendering result corresponding to each target object to be displayed, based on the second pose, and the original map and the first attribute information respectively corresponding to each target object to be displayed, and determine a second rendering result corresponding to each background map based on the second pose, and the at least one background map corresponding to the other objects to be displayed; and determine the image to be displayed based on each first rendering result, the layer level of each target object to be displayed, each second rendering result, and the layer level corresponding to each background map.

In some optional embodiments of the present disclosure, the second processing module 800 is specifically configured to:
for any target object to be displayed, determine sampling coordinates of pixels of the image to be displayed in the original map of the target object to be displayed, based on the second pose, and the original map and the first attribute information of the target object to be displayed; and determine a first rendering result corresponding to the target object to be displayed, based on the sampling coordinates of the pixels in the original map of the target object to be displayed.

In some optional embodiments of the present disclosure, the second processing module 800 is specifically configured to:
for any background map, determine sampling coordinates of pixels of the image to be displayed in the background map based on the second pose; and determine a second rendering result corresponding to the background map based on the sampling coordinates of the pixels in the background map.

In some optional embodiments of the present disclosure, the second processing module 800 is specifically configured to:
from layer levels with unprocessed statuses, determine a layer level with the greatest depth as a current layer level, wherein initial processing statuses of all layer levels are unprocessed; based on sampling coordinates of pixels of the image to be displayed, fuse a rendering result of the current layer level with a preceding rendering result to obtain a current rendering result, wherein the preceding rendering result is initially empty; update the processing status of the current layer level to processed, and update the preceding rendering result with the current rendering result; repeat the step of determining, from layer levels with unprocessed statuses, a layer level with the greatest depth as a current layer level; and in response to processing statuses of all layer levels being processed, use the preceding rendering result as the image to be displayed.

In some optional embodiments of the present disclosure, the second processing module 800 is specifically configured to:
determine, from layer levels with unprocessed statuses, a preset number of layer levels with the greatest depths as current target layer levels, wherein initial processing statuses of all layer levels are unprocessed; based on sampling coordinates of pixels of the image to be displayed, fuse rendering results of the current target layer levels with a preceding rendering result in the order of layer levels to obtain a current rendering result, wherein the preceding rendering result is initially empty; update the processing statuses of the current target layer levels to processed, and update the preceding rendering result with the current rendering result; repeat the step of determining, from layer levels with unprocessed statuses, a preset number of layer levels with the greatest depths as current target layer levels; and in response to processing statuses of all layer levels being processed, use the preceding rendering result as the image to be displayed.

In some optional embodiments of the present disclosure, the second processing module 800 is specifically configured to:
based on sampling coordinates of pixels of the image to be displayed, fuse rendering results of all layer levels in the order of layer levels to obtain the image to be displayed.

In some optional embodiments of the present disclosure, the second processing module 800 is specifically configured to:
for any pixel of the image to be displayed, respectively determine sampling coordinates corresponding to the pixel at each layer level based on the second pose, and fuse color values at corresponding sampling coordinates at all layer levels in maps corresponding to the layer levels in the order of layer levels to obtain a color value corresponding to the pixel.

In some optional embodiments of the present disclosure, the second processing module 800 is specifically configured to:
for any pixel of the image to be displayed, respectively determine sampling coordinates corresponding to the pixel in each map based on the second pose, and fuse color values in all maps at corresponding sampling coordinates in the maps in the depth order of the maps under the second pose to obtain a color value corresponding to the pixel.

In some optional embodiments of the present disclosure, the third processing module 900 is specifically configured to:
determine the layer level of each target object to be displayed and the layer level corresponding to each background map, according to a positional relationship among all target objects to be displayed and all background maps when the terminal device is in a target pose, wherein the target pose includes any one of the first pose and the second pose; and the positional relationship includes at least one of depth and occlusion.

In some optional embodiments of the present disclosure, the third processing module 900 is specifically configured to:
determining the layer level of each target object to be displayed and the layer level corresponding to each background map, according to categories of all target objects to be displayed and all background maps, as well as a positional relationship among all target objects to be displayed and all background maps when the terminal device is in a target pose, wherein the categories include a target category and a background category; the target pose includes any one of the first pose and the second pose; and the positional relationship includes at least one of depth and occlusion.

In some optional embodiments of the present disclosure, the background category includes a foreground type and a rear background type.

In some optional embodiments of the present disclosure, the second processing module 800 is specifically configured to:
in the case where the other objects to be displayed correspond to one background map, and a layer level corresponding to the background map is a topmost layer, if at least a portion of a second rendering result corresponding to the background map is occluded by the target object to be displayed, set the opacity of pixels in an occluded portion of the second rendering result to transparency; and fuse rendering results of layer levels in the order of layer levels to obtain the image to be displayed.

In some optional embodiments of the present disclosure, the second processing module 800 is specifically configured to:
in the case where the other objects to be displayed correspond to one background map, and a layer level corresponding to the background map is a topmost layer, if at least a portion of the background map needs to be occluded by the target object to be displayed under the second pose, set the opacity of pixels in an occluded portion of the background map to transparency, wherein the target object to be displayed is determined by the corresponding original map and first attribute information; and fuse maps in the depth order of the maps under the second pose to obtain the image to be displayed.

It should be noted that the specific implementation of the display apparatus for objects to be displayed in embodiments of the present disclosure is similar to the specific implementation of the display method for objects to be displayed in embodiments of the present disclosure. For details, please refer to the section on the display method for objects to be displayed. To avoid redundancy, description is omitted here.

### Exemplary Electronic Device

Embodiments of the present disclosure further provide an electronic device, including: a processor and a memory configured to store instructions executable by the processor.

The processor is configured to read the executable instructions from the memory and execute the instructions to implement the display method for objects to be displayed according to any of the above-described embodiments of the present disclosure.

### Exemplary Head-Mounted Display Device

Embodiments of the present disclosure further provide a head-mounted display device, including: a processor and a memory configured to store instructions executable by the processor.

The processor is configured to read the executable instructions from the memory and execute the instructions to implement the display method for objects to be displayed according to any of the above-described embodiments of the present disclosure.

FIG. 9 is a schematic structural diagram of an application embodiment of an electronic device of the present disclosure. For the structure of the head-mounted display device, reference may be made to the structure of the electronic device. In this embodiment, the electronic device includes one or more processors 100 and a memory 200.

The processor 100 may be a central processing unit (CPU) or another form of processing unit having data processing capabilities and/or instruction execution capabilities, and may control other components in the electronic device to perform desired functions.

The memory 200 may include one or more computer program products. The computer program products may include various forms of computer-readable storage media, such as a volatile memory and/or a non-volatile memory. The volatile memory may, for example, include random access memory (RAM) and/or a cache memory (cache), etc. The non-volatile memory may, for example, include a read-only memory (ROM), a hard disk, a flash memory, etc. One or more computer program instructions may be stored on the computer-readable storage medium, and the processor 11 may execute the program instructions to implement the method in the embodiments of the present disclosure described above and/or other desired functions. Various contents such as input signals, signal components, noise components, etc. may also be stored in the computer-readable storage medium.

In an example, the electronic device may further include input means 300 and output means 400. The components are interconnected via a bus system and/or other form of connecting mechanisms (not shown).

For example, the input means 300 may be the above-mentioned microphone or microphone array, configured to capture input signals from sound sources.

In addition, the input means 300 may also include, for example, a keyboard, a mouse, and so on.

The output means 400 may output various information to the outside, including determined distance information, direction information, etc. The output means 400 may include, for example, a display, a speaker, a printer, as well as a communications network and a remote output device connected thereto, and so on.

Of course, for simplicity, only some of components of the electronic device relevant to the present disclosure are shown in FIG. 9, while components such as buses, input/output interfaces, and the like are omitted. In addition, depending on a specific application, the electronic device may further include any other appropriate components.

### Exemplary Computer Program Product and Computer-Readable Storage Medium

In addition to the method and device described above, embodiments of the present disclosure may also be a computer program product including computer program instructions. The computer program instructions, when executed by a processor, cause the steps in the method according to various embodiments of the present disclosure as described in the above-described “Exemplary method” section of this specification to be implemented.

The computer program product may use any combination of one or more programming languages to write program code for performing operations of the embodiments of the present disclosure. The programming languages include an object-oriented programming language such as Java or C++, and also include a conventional procedural programming language, such as “C” language or a similar programming language. The program code may be executed entirely on a user's computing device, partly on a user's device, as an independent software package, partly on a user's computing device and partly on a remote computing device, or entirely on a remote computing device or server.

In addition, embodiments of the present disclosure may also be a computer-readable storage medium configured to store a computer program. The computer program is configured to execute the steps in the method according to various embodiments of the present disclosure as described in the above-described “Exemplary method” section of this specification.

The computer-readable storage medium may be any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory ((CD-ROM), an optical storage device, a magnetic storage device, or any suitable combination thereof.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A display method for objects to be displayed, comprising:
obtaining an original map and first attribute information respectively corresponding to at least one target object to be displayed;
rendering other objects to be displayed except the target object to be displayed based on a first pose of a terminal device and second attribute information respectively corresponding to the other objects to be displayed to obtain at least one background map, wherein both the first attribute information and the second attribute information comprise position, angle, and scaling; and
determining an image to be displayed based on the original map and the first attribute information respectively corresponding to each target object to be displayed, the at least one background map corresponding to the other objects to be displayed, and a second pose of the terminal device, wherein the second pose is obtained at a time later than a time when the first pose is obtained.

2. The method according to claim 1, further comprising:
determining a layer level of each target object to be displayed and a layer level corresponding to each background map according to a preset rule.

3. method according to claim 2, wherein determining an image to be displayed based on the original map and the first attribute information respectively corresponding to each target object to be displayed, the at least one background map corresponding to the other objects to be displayed, and a second pose of the terminal device comprises:
determining a first rendering result corresponding to each target object to be displayed, based on the second pose, and the original map and the first attribute information respectively corresponding to each target object to be displayed;
determining a second rendering result corresponding to each background map based on the second pose, and the at least one background map corresponding to the other objects to be displayed; and
determining the image to be displayed based on each first rendering result, the layer level of each target object to be displayed, each second rendering result, and the layer level corresponding to each background map.

4. The method according to claim 3, wherein determining a first rendering result corresponding to each target object to be displayed, based on the second pose, and the original map and the first attribute information respectively corresponding to each target object to be displayed comprises:
for any target object to be displayed, determining sampling coordinates of respective pixels of the image to be displayed in the original map of the target object to be displayed, based on the second pose, and the original map and the first attribute information of the target object to be displayed; and
determining the first rendering result corresponding to the target object to be displayed, based on the sampling coordinates of the pixels in the original map of the target object to be displayed.

5. The method according to claim 3, wherein determining a second rendering result corresponding to each background map based on the second pose, and the at least one background map corresponding to the other objects to be displayed comprises:
for any background map, determining sampling coordinates of respective pixels of the image to be displayed in the background map based on the second pose; and
determining the second rendering result corresponding to the background map based on the sampling coordinates of the pixels in the background map.

6. The method according to claim 3, wherein determining the image to be displayed based on each first rendering result, the layer level of each target object to be displayed, each second rendering result, and the layer level corresponding to each background map comprises:
determining, from layer levels with unprocessed statuses, a layer level with a greatest depth as a current layer level, wherein initial processing statuses of all layer levels are unprocessed;
fusing a rendering result of the current layer level with a preceding rendering result, based on sampling coordinates of pixels of the image to be displayed, to obtain a current rendering result, wherein the preceding rendering result is initially empty;
updating a processing status of the current layer level to processed, and updating the preceding rendering result with the current rendering result;
repeating the step of determining, from the layer levels with unprocessed statuses, the layer level with a greatest depth as a current layer level; and
in response to processing statuses of all the layer levels being processed, using the preceding rendering result as the image to be displayed.

7. The method according to claim 3, wherein determining the image to be displayed based on each first rendering result, the layer level of each target object to be displayed, each second rendering result, and the layer level corresponding to each background map comprises:
determining, from the layer levels with unprocessed statuses, a preset number of layer levels with greatest depths as current target layer levels, wherein initial processing statuses of all the layer levels are unprocessed;
fusing rendering results of the current target layer levels with a preceding rendering result in an order of the layer levels, based on sampling coordinates of pixels of the image to be displayed, to obtain a current rendering result, wherein the preceding rendering result is initially empty;
updating processing statuses of the current target layer levels to processed, and updating the preceding rendering result with the current rendering result;
repeating the step of determining, from the layer levels with unprocessed statuses, a preset number of layer levels with greatest depths as current target layer levels; and
in response to processing statuses of all layer levels being processed, using the preceding rendering result as the image to be displayed.

8. The method according to claim 3, wherein determining the image to be displayed based on each first rendering result, the layer level of each target object to be displayed, each second rendering result, and the layer level corresponding to each background map comprises:
fusing rendering results of all the layer levels in an order of the layer levels to obtain the image to be displayed, based on sampling coordinates of pixels of the image to be displayed.

9. The method according to claim 2, wherein determining the image to be displayed based on the original map and the first attribute information respectively corresponding to each target object to be displayed, the at least one background map corresponding to the other objects to be displayed, and a second pose of the terminal device comprises:
for any pixel of the image to be displayed, respectively determining sampling coordinates corresponding to the pixel at each layer level based on the second pose, and
fusing color values at corresponding sampling coordinates at all the layer levels in maps corresponding to the layer levels in the order of the layer levels to obtain a color value corresponding to the pixel.

10. The method according to claim 2, wherein determining a layer level of each target object to be displayed and a layer level corresponding to each background map according to a preset rule comprises:
determining a layer level of each target object to be displayed and a layer level corresponding to each background map, according to categories of all of the target objects to be displayed and all of the background maps, as well as a positional relationship among all of the target objects to be displayed and all of the background maps when the terminal device is in a target pose, wherein the categories comprise a target category and a background category; the target pose comprises any one of the first pose and the second pose; and a positional relationship comprises at least one of depth and occlusion.

11. The method according to claim 3, wherein determining the image to be displayed based on each first rendering result, the layer level of each target object to be displayed, each second rendering result, and the layer level corresponding to each background map comprises:
in the case where the other objects to be displayed correspond to one background map, and a layer level corresponding to the background map is a top layer, if at least a portion of the second rendering result corresponding to the background map needs to be occluded by the target object to be displayed, setting opacity of pixels in an occluded portion of the second rendering result to transparent; and
fusing rendering results of each of the layer levels in the order of all of the layer levels to obtain the image to be displayed.

12. The method according to claim 1, wherein determining an image to be displayed based on the original map and the first attribute information respectively corresponding to each target object to be displayed, the at least one background map corresponding to the other objects to be displayed, and a second pose of the terminal device comprises at least one of:
for any pixel of the image to be displayed, respectively determining sampling coordinates corresponding to the pixel in each of map based on the second pose, and fusing color values in all of the maps at corresponding sampling coordinates in the maps in a depth order of the maps under the second pose to obtain a color value corresponding to the pixel;
in the case where the other objects to be displayed correspond to one background map, and a layer level corresponding to the background map is a top layer, if at least a portion of the background map needs to be occluded by the target object to be displayed under the second pose, setting opacity of the pixels in an occluded portion of the background map to transparent, wherein the target object to be displayed is determined by the corresponding original map and the first attribute information; and
fusing maps in a depth order of the maps under the second pose to obtain the image to be displayed.

13. The method according to claim 1, wherein obtaining an original map and first attribute information respectively corresponding to at least one target object to be displayed comprises one of:
for a document-type target object to be displayed, obtaining the original map through a text editor;
for a web-page-type target object to be displayed, obtaining the original map through a browser;
for a video-type target object to be displayed, obtaining the original map through a video player; and
for an image-type target object to be displayed, obtaining the original map through an image viewer.

14. (canceled)

15. An electronic device, comprising:
a processor; and
a memory configured to store instructions executable by the processor, wherein
the processor is configured to read the executable instructions from the memory and execute the instructions to implement a display method for objects to be displayed, the objects to be displayed comprising a target object to be displayed and other objects to be displayed, the other objects to be displayed comprising at least one of a rear background type of objects to be displayed and a foreground type of objects to be displayed, the method comprising:
obtaining an original map and first attribute information of at least one target object to be displayed;
rendering other objects to be displayed based on a first pose of the electronic device and second attribute information of the other objects to be displayed to obtain at least one background map;
determining a first rendering result corresponding to the target object to be displayed based on a second pose of the electronic device, the original map, and the first attribute information, wherein the second pose is obtained at a time later than a time when the first pose is obtained;
determining a second rendering result corresponding to the at least one background map based on the second pose and the at least one background map; and
determining an image to be displayed based on the first rendering result and the second rendering result.

16. The electronic device according to claim 15, wherein obtaining an original map and first attribute information of at least one target object to be displayed comprises one of:
for a document-type target object to be displayed, obtaining the original map through a text editor;
for a web-page-type target object to be displayed, obtaining the original map through a browser;
for a video-type target object to be displayed, obtaining the original map through a video player; and
for an image-type target object to be displayed, obtaining the original map through an image viewer.

17. The method according to claim 1, wherein determining an image to be displayed based on the original map and the first attribute information respectively corresponding to each target object to be displayed, the at least one background map corresponding to the other objects to be displayed, and a second pose of the terminal device comprises:
for any pixel of the image to be displayed, respectively determining sampling coordinates corresponding to the pixel in each of map based on the second pose, and fusing color values in all of the maps at corresponding sampling coordinates in the maps in a depth order of the maps under the second pose to obtain a color value corresponding to the pixel.

18. The method according to claim 2, wherein determining a layer level of each target object to be displayed and a layer level corresponding to each background map according to a preset rule comprises:
determining a layer level of each target object to be displayed and a layer level corresponding to each background map, according to a positional relationship among all of the target objects to be displayed and all of the background maps when the terminal device is in a target pose, wherein a target pose comprises any one of the first pose and the second pose; and a positional relationship comprises at least one of depth and occlusion.

19. A display method for objects to be displayed for a head-mounted display device, the objects to be displayed comprising a target object to be displayed and other objects to be displayed, the target object to be displayed having a first clarity requirement, and the other objects to be displayed having a second clarity requirement, the first clarity requirement being higher than the second clarity requirement, the method comprising:
obtaining an original map and first attribute information of at least one target object to be displayed;
rendering other objects to be displayed based on a first pose of the head-mounted display device and second attribute information of the other objects to be displayed to obtain at least one background map;
determining a first rendering result corresponding to the target object to be displayed based on a second pose of the head-mounted display device, the original map, and the first attribute information, wherein the second pose is obtained at a time later than a time when the first pose is obtained;
determining a second rendering result corresponding to the at least one background map based on the second pose and the at least one background map; and
determining an image to be displayed based on the first rendering result and the second rendering result.

20. The method according to claim 19, wherein the method further comprising determining the image to be displayed based on the first rendering result, a layer level of the target object to be displayed, the second rendering result, and a layer level corresponding to the background map.

21. The method according to claim 19, wherein obtaining an original map and first attribute information of at least one target object to be displayed comprises one of:
for a document-type target object to be displayed, obtaining the original map through a text editor;
for a web-page-type target object to be displayed, obtaining the original map through a browser;
for a video-type target object to be displayed, obtaining the original map through a video player; and
for an image-type target object to be displayed, obtaining the original map through an image viewer.
